(19) United States
(12) Patent Application Publication
(10) Pub. No.: US 2020/0238110 A1
(43) Pub. Date: Jul. 30, 2020

(54) Articulating Support Assembly For A Self-Contained Breathing Apparatus

(71) Applicant: 3M INNOVATIVE PROPERTIES COMPANY, ST. PAUL, MN (US)

(72) Inventors: Darrill L. Plummer, Midland, NC (US); Robert D. Williams, Monroe, NC (US); Jhansi R. Arikatla, Waxhaw, NC (US); Elliott Chase Miller, Monroe, NC (US); Joseph S. Toro, E. Patchogue, NY (US); Jason R. Cannon, Waxhaw, NC (US)

(21) Appl. No.: 16/639,019

(22) PCT Filed: Oct. 18, 2018
(86) PCT No.: PCT/IB2018/058103

§ 371 Date: Feb. 13, 2020

Related U.S. Application Data
(60) Provisional application No. 62/573,922, filed on Oct. 18, 2017.

(51) Int. Cl. A62B 9/04; A62B 25/00

(52) U.S. Cl. CPC A62B 9/04; A45F 3/14; A62B 25/00

(57) ABSTRACT

A support assembly for a self-contained breathing apparatus includes a back frame for supporting the self-contained breathing apparatus on a user's back, the back frame having upper and lower regions, a waist pad removably attached to the lower region of the back frame, and a first elongate securing member arranged to removably secure the back frame to the waist pad, wherein the first elongate securing member is configured to allow the waist pad to move within a predetermined range of motion with respect to the back frame.

### BACKGROUND

The present invention relates generally to self-contained breathing apparatus worn on the back of a user and, more particularly, to self-contained breathing apparatus having an articulating support assembly.

Self-contained breathing apparatus (SCBA), sometimes referred to as a compressed air breathing apparatus (CABA), are devices used by, for example, first responders such as firefighters, law enforcement, military and other rescue and emergency workers when operating in hazardous or dangerous environments. An SCBA typically includes several primary components including a pressure air tank or cylinder, a pressure regulator, an inhalation connection, such as a mouthpiece or face mask, and a carrying frame or support assembly that is worn by the user.

Breathing apparatus are generally known in the prior art. U.S. Pat. No. 7,191,790 (Mele), for example, describes a quick connect pressure reducer and cylinder valve for use with an SCBA. U.S. Pat. No. 9,004,068 (Phifer et. al.) describes a self-contained breathing apparatus including an air cylinder pressurized to about 5500 psi. The SCBA includes first and second regulator valves, a mask, and a frame for supporting the air cylinder on the back of the operator. U.S. Pat. No. 9,257,028 (Parkulo), describes a portable device that can be used with a breathing apparatus such as an SCBA. The contents of U.S. Pat. No. 7,191,790 (Mele), U.S. Pat. No. 9,004,068 (Phifer et. al.) and U.S. Pat. No. 9,257,028 (Parkulo) are hereby incorporated by reference.

Self-contained breathing apparatus continue to be an indispensable piece of equipment in a wide variety of situations and environments. As such, there continues to be a need to improve the performance and use of such equipment. In particular, there is an ongoing need to improve the comfort, use, durability, care (e.g. maintainability and cleanability), and repairability of the carrying frame or support assembly used to support an SCBA on the back of an operator.

### SUMMARY

The present disclosure provides a breathing apparatus, such as a self-contained breathing apparatus (SCBA) including, for example, a pressure air tank or cylinder, a pressure regulator, an inhalation connection, such as a mouthpiece or face mask, and a carrying frame or support assembly that is worn by the user.

In one embodiment, the present disclosure provides an SCBA including a support assembly comprising a back frame configured to be worn on a user's back, a waist pad removably attached to a lower region of the back frame, and a first elongate securing member arranged to removably secure the back frame to the waist pad, wherein the first elongate securing member is configured to allow the waist pad to move within a predetermined range of motion with respect to the back frame.

Advantages of certain embodiments of the SCBA and support assembly described herein include that the support assembly allows for increased mobility and freedom of movement, thereby increasing the level of comfort for the wearer, that the SCBA can be readily assembled and disassembled without the use of tools, and that all of the fabric components of the support assembly including, for example, the waist pad, shoulder harness assembly and pouch for stowing the Emergency Breathing Support System (EBSS), can be easily removed and replaced for cleaning, maintenance and/or repair.

### BRIEF DESCRIPTION OF THE DRAWINGS

FIG. 1 is a partially exploded perspective view showing an SCBA support assembly according to an embodiment of the invention.

FIG. 2 is a perspective view of the SCBA support assembly of FIG. 1 showing the support assembly in its assembled condition.

FIG. 2A is a detailed view of the region designated A in FIG. 2.

FIG. 3 is a back plan view of the SCBA support assembly of FIG. 2.

FIG. 4 is a front plan view of the SCBA support assembly of FIG. 2.

FIG. 5 is a plan view of an Emergency Breathing Support System (EBSS) pouch for use with the SCBA support assembly illustrated in FIGS. 1-4.

### DETAILED DESCRIPTION

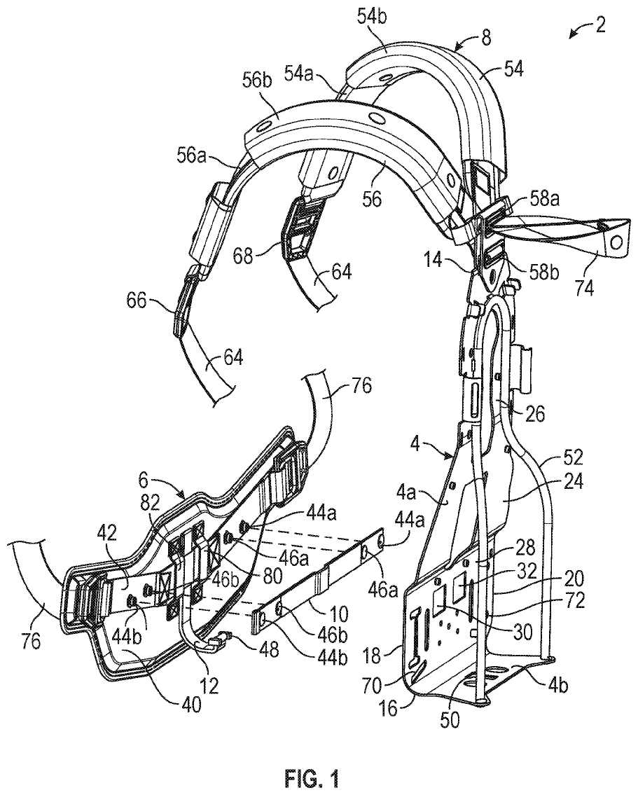

Referring now to the drawings, wherein like reference numerals refer to like or corresponding parts throughout the several views, FIGS. 1-4 show a support assembly 2 for supporting a self-contained breathing apparatus (SCBA) on a user's back. In addition to the support assembly 2, the SCBA may include other components typically associated with an SCBA such as a pressure air tank or cylinder, at least one pressure regulator, and an inhalation connection, such as a mouthpiece or face mask. To allow the support assembly 2 to be seem more clearly, the pressure air tank, pressure regulator(s), and inhalation connection are not shown in the figures. In the illustrated embodiment, the support assembly 2 generally includes a back frame 4, a waist pad 6, a shoulder harness assembly 8, and a pair of elongate securing members 10, 12. These features are described in detail below.

The back frame 4 is configured to be positioned adjacent a user's back when the support assembly 2 is worn by the user. In the illustrated embodiment, the back frame 4 is generally rigid and has a unitary (i.e. one-piece) construction. In one embodiment, the back frame 4 may be formed of sheet metal, such as steel or aluminum, but other light weight high strength materials, such as composites, may be used.

The back frame 4 includes an upper edge 14, a lower edge 16, a pair of side edges 18, 20, and opposed first and second major surfaces 22, 24. The back frame 4 includes a backrest portion 4a and a shelf portion 4b extending outwardly generally perpendicularly from the lower edge 16 of the backrest portion 4a. Configured in this manner, the backrest portion 4a and shelf portion 4b combine to form a generally L-shaped back frame 4. The backrest portion 4a includes an upper region 26 for positioning adjacent the upper back of the user, and a lower region 28 for positioning adjacent the lower back of the user when the SCBA support assembly 2 is worn by a user. In the illustrated embodiment, the upper and lower regions 26, 28 are offset (i.e. the backrest portion 4a is not planar). The offset is provided to match the curved profile of a user's back, thereby providing an ergonomic and more comfortable fit for the user.

In the illustrated embodiment, the first and second elongate securing members 10, 12 removably secure the waist pad 6 to the lower region 28 of the backrest portion 4b of the back frame 4. The first and second elongate securing members 10, 12 may be, for example, generally flat strips of material and/or flexible straps. The flexible straps may be formed from a variety of materials including, for example, synthetic plastic materials, natural materials such as leather, metals, and combinations thereof. The particular material selected for the straps 10, 12 is not significant to the invention hereof, so long as it provides the desired properties such as adequate strength, durability and heat resistance. In one embodiment, the flexible straps may comprise woven fabric. In a preferred embodiment, the flexible straps comprise webbing formed of high strength synthetic aramid fibers, such as Kevlar, Nomex, Technora, and Twaron and combinations thereof. Other suitable materials include polyethylene, polypropylene or polyester, including Dyneema and Spectra, which may be blended or combined with any of the foregoing materials.

The waist pad 6 may be, for example, a cushioned pad having a front face 38 for contacting the lower back region of the user, and a back face 40 opposite the front face 38. In the illustrated embodiment—to provide added strength—the back face 40 of the waist pad 6 includes a reinforced region 42 comprising webbing permanently affixed (e.g. by stitching or adhesively bonded) to the waist pad 6. The reinforced region 42 serves to strengthen the region of the waist pad where the first strap 10 is attached, and also serves to distribute the load imparted by the first strap 10 to the waist pad 6 over a larger area. The waist pad 6 also includes an adjustable belt 76 for securing the waist pad 6 around the waist of a user. The belt 76 may be integrated into, or be provided as part of, the waist pad 6, or it may be provided as one or more separate components that may be removably attached to the ends of the waist belt 6.

To allow the waist pad 6 and back frame 4 to be readily separated, at least one end of the first strap 10 is removably connected with the back frame 4 and/or waist pad 6. In the illustrated embodiment, each end of the first strap 10 is removably connectable with the waist pad 6. More specifically, each end of the first strap 10 includes a pair of snap fasteners 44a, 46a, 44b, 46b for removably attaching the first strap 10 to the reinforced region 42 of the waist pad 6, thereby allowing the waist pad 6 and back frame 4 to be manually connected and separated without the use of tools. Suitable snap fasteners include Pull-the-DOT locking snap fasteners available from Scovill Fasteners, Clarkesville, Ga. While snap fasteners have been found to have particular utility for providing the removable connection between the first strap 10 and the waist strap 6, other fasteners, such as clips or slide plates, may also be used.

In the illustrated embodiment, the first strap 10 slidably engages the lower region 28 of the back frame 4, thereby permitting a limited degree of side-to-side movement between the waist pad 6 and the back frame 4. More specifically, as shown most clearly in FIG. 1, the first strap 10 slidably engages a pair of spaced openings 30, 32 contained in the lower region 28 of the backrest portion 4a of the back frame 4. To provide a more secure connection between the first strap 10 and the waist pad 6, the first strap 10 is threaded through a pair of strap loops 80, 82 provided on the back face 40 of the waist pad 6. The ends of the strap loops 80, 82 are permanently secured to the back face 40 of the waist pad 6 by, for example, heavy duty box stitching, thereby forming openings through which the first strap 10 is slidably inserted. In this manner, the strap loops 80, 82 serve to removably slidably secure the first strap 10 to the waist pad 6.

In one aspect, the length and width dimensions of the openings 30, 32 are greater than the width of the first strap 10. This allows freedom of movement between the strap 10 within the openings 30, 32, thereby minimizing the likelihood of pinching and binding, and also reducing wear of the strap 10.

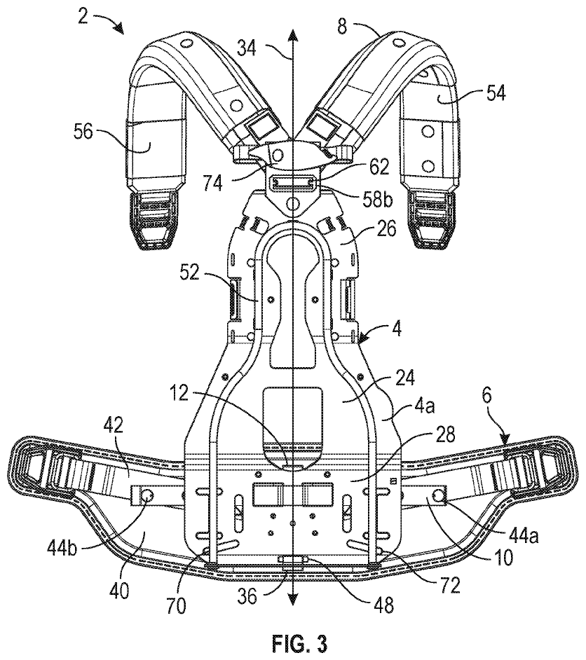

As shown most clearly in FIG. 3, the back frame 4 includes a longitudinal axis 34, and when the first strap 10 is arranged in its securing position to connect the back frame 4 and the waist pad 6, the first strap 10 extends generally perpendicularly to the back frame longitudinal axis 34 and along the length of the waist pad 6. That is, the openings 30, 32 that slidably receive the first strap 10 are transversely spaced relative to the longitudinal axis 34 of the back frame 4.

In one aspect, when the first strap 10 is secured to the back frame 4 and fastened to the waist pad 6, the first strap 10 serves to maintain the waist pad 6 in close proximity to the lower region 28 of the backrest portion 4b of the back frame 4. By doing so, the first strap 10 reduces the likelihood of the second strap 12 inadvertently disconnecting from the back frame 4. In addition, in the unlikely event that the second strap 12 fails or inadvertently becomes disconnected from the back frame 4, the first strap 10 is designed to independently support the load carried by the support assembly 2, thereby providing redundancy for the connection between the back frame 4 and the waist pad 6.

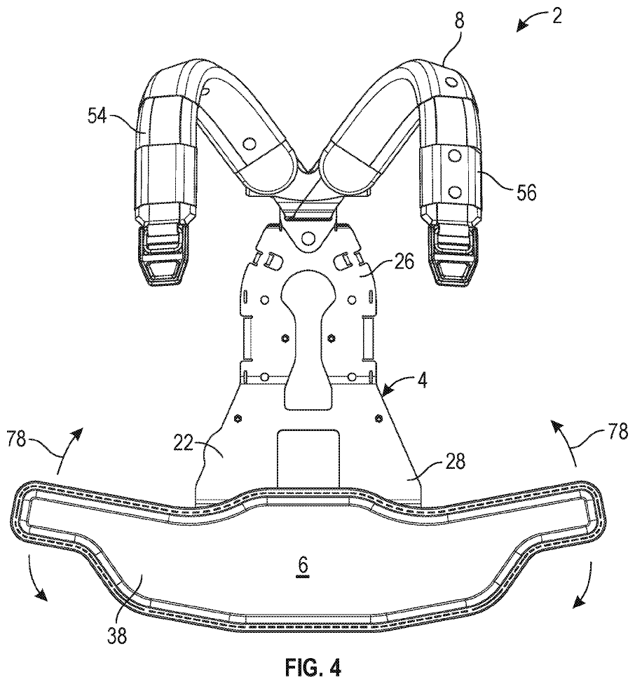

The second elongate securing member 12 also serves to removably connect the waist pad 6 and the back frame 4. The second elongate securing member 12 comprises a second flexible strap having a first end permanently affixed to the waist pad 6. In the illustrated embodiment, the first end is affixed to the waist pad 6 in a region between the two areas where the first strap 10 attaches to the waist pad 6 and between the strap loops 80, 82. The second elongate securing member 12 also includes a second free end that extends outwardly away from the waist pad 6 for engagement with the back frame 4. As shown most clearly in FIG. 1, the second strap 12 is arranged generally perpendicular to the first strap 10 (i.e. generally parallel to the back frame longitudinal axis 34). Arranged in this manner, the first and second straps 10, 12 combine and cooperate to form a flexible connection that provides a joint or pivot point 36 (FIG. 3) between the back frame 4 and waist pad 6 that allows the waist pad 6 to pivot up and down within a predetermined range of motion with respect to the pivot point 36 and the back frame 4. That is, the straps 10, 12 allow the waist pad 6 to pivot or rotate with respect to the back frame 4 as indicated by the arrows 78 shown in FIG. 4. The pivot point 36 is located along the lower edge 16 of the back frame 4 where the second strap 12 contacts the bottom surface of the shelf portion 4b of the back frame 4.

The free end of the second strap 12 includes a retaining element 48 configured to interlock with a mating slot 50 provided in the shelf portion 4b of the back frame 4. The retaining element 48 may be, for example, an I-bar that is manually insertable through the slot 50 and is removably retained therein. When the support assembly 2 is carrying a load, the second strap 12 is placed in tension which, in turn, urges the I-bar toward the second major surface 24 of the lower region 28 of the backrest portion 4a of the back frame 4. This force serves to securely hold the I-bar in place adjacent the lower backrest portion 4a second major surface 24. Configured in this manner, the second strap 12 tends to serve as the primary load carrying strap.

In the illustrated embodiment, the back frame 4 further comprises a reinforcing member or bar 52 that extends from the shelf portion 4b to the upper region 26 of the backrest portion 4a. Arranged in this manner, the reinforcing bar 52 and back frame 4 combine to form a truss-like structure capable of safely and securely carrying significant loads.

The shoulder harness assembly 8 enables the support assembly 2 to be removably secured around the shoulders of the user. Like the waist pad 6, the shoulder harness assembly 8 may be manually connected with and removed from the back frame 4. In the illustrated embodiment, the shoulder harness assembly 8 includes a pair of shoulder pads 54, 56 that are removably connected with the back frame 4. More specifically, each shoulder pad includes an upper end removably connectable with the upper region 26 of the back frame 4 and a lower end removably connectable with the lower region 28 of the back frame 4.

In the illustrated embodiment, the upper ends of the shoulder pads 54, 56 include an attachment strap 74 that forms a loop. The loop serves as a handle that may be manually grasped by another individual to pull an immobile user wearing the SCBA support assembly 2 to safety. The attachment strap 74 includes a retaining device for removably securing the attachment strap 74 to the back frame 4. Suitable retaining devices include, for example, clips, snaps and buckles. In the illustrated embodiment, the retaining device comprises a pair of slide plates 58a, 58b. Suitable slide plates include, for example, Tri-Slide slide plates available from AAA Technology & Specialties Co, Inc. Houston, Tex.

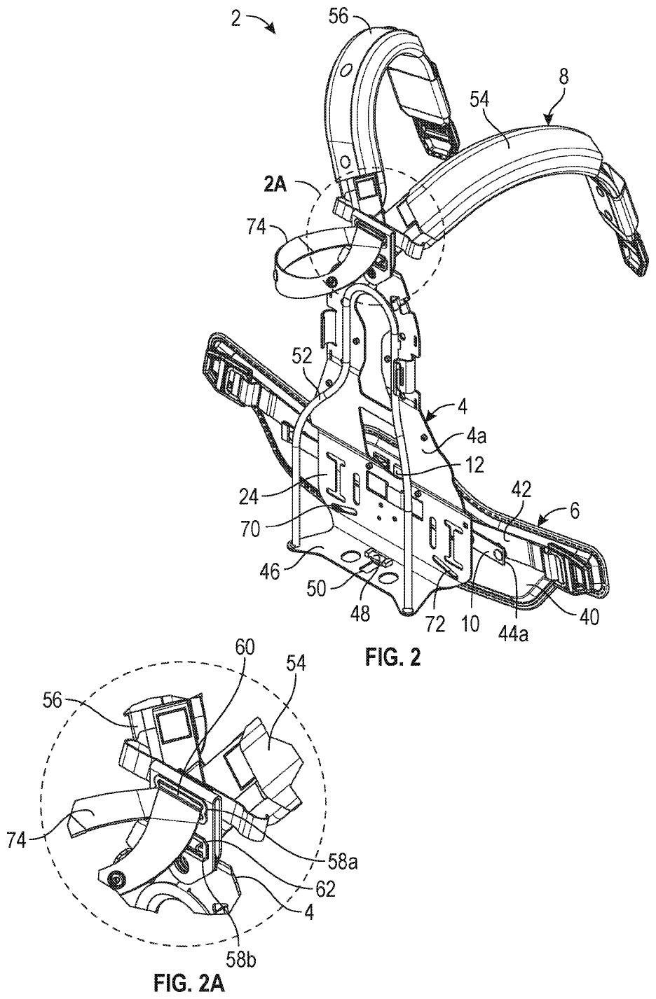

The upper region 26 of the back frame 4 contains a pair of slots 60, 62 for matingly receiving the slide plates 58a, 58b, respectively—best seen in FIG. 2A—thereby providing manually releasable engagement between the upper ends of the shoulder pads 54, 56 and the upper region 26 of the back frame 4. The shoulder pads 54, 56 are connected with the upper end of the back frame 4 by manually sliding the slide plates 58a, 58b through the slots 60, 62, respectively. By providing mating pairs of slide plates 58a, 58b and slots 60, 62, when the assembled SCBA support assembly 2 is worn by a user and the SCBA support assembly 2 is used to carry a load, the lower slide plate 58b serves as the primary load bearing support, and when the SCBA support assembly 2 is not worn by a user, the upper slide plate 58a tends to bias the shoulder pads 54, 56 outwardly away from the back frame 4, thereby making it easier for the user to put on the backpack assembly 2. That is, when the SCBA support assembly is to be worn by a user, the upper slide plate 58a causes the shoulder pads to “present” to the user, thereby making it easier and faster for the user to don the SCBA support assembly 2.

The lower ends of the shoulder pads 54, 56 are connected with the lower region 28 of the back frame 4 by an adjustable waist-to-shoulder pad extension strap 64 as partially shown in FIG. 1. In the illustrated embodiment, the lower ends of the shoulder pads include buckles 66, 68 for slidably and adjustably receiving opposed ends of the waist-to-shoulder pad extension strap 64. The waist-to-shoulder pad extension strap 64 slidably engages the angled slots 70, 72 provided in the lower region 28 of the backrest portion 4a along the lower edge 16 of the back frame 4. Arranged in this manner, the waist-to-shoulder pad extension strap 64 may be manually slidably released from the back frame 4. Alternatively, separate waist-to-shoulder pad extension straps may be provided to removably and adjustably secure the lower ends of the shoulder pads 54, 56 with the lower region 28 of the backrest portion 4a of the back frame 4. If connected in this manner, the ends of waist-to-shoulder pad extension straps may include retaining devices (not shown) configured to matingly engage slots 70, 72 provided in the lower region of the back frame, thereby providing manual releasable engagement between the waist-to-shoulder pad extension straps and the lower region of the back frame. The retaining devices may be, for example, slide plates similar to slides plates 58a, 58b, although other retaining devices such as clips or snap fasteners may be used.

When the shoulder harness assembly 8 is secured to the back frame 4 in the manner described above, it will be apparent that the shoulder harness assembly 8 and back frame 4 may be readily manually connected and disconnected without the use of tools. In addition, each shoulder pad 54, 56 includes a primary portion 54a, 56a and a flap portion 54b, 56b arranged to form a raceway for receiving one or more hoses, tubes, wires, cables, and the like. The flap portions 54b, 56b can be arranged in overlapping relation with the primary portion 54a, 54b and include at least one end removably coupled with the primary portion 54a, 56a, thereby providing easy access to the raceway. Configured in this manner allows the shoulder harness assembly 8 to be manually separated from the back frame 4 without tools and without disconnecting any electrical or pneumatic lines (i.e. hoses, tubes, wires or cables).

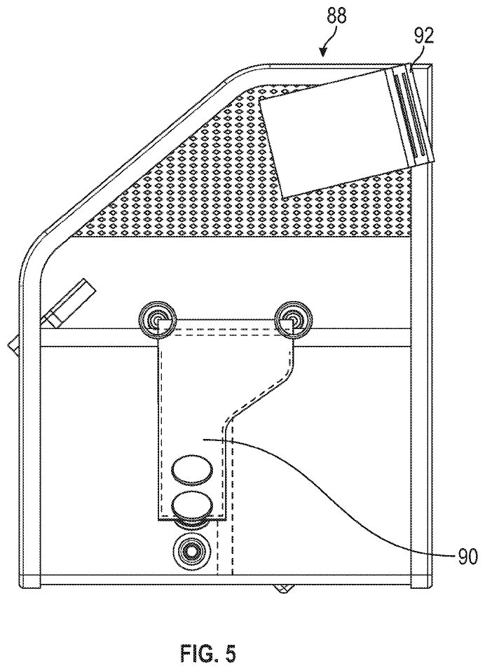

Referring to FIG. 5, the support assembly 2 may further include a pouch 88 for stowing an Emergency Breathing Support System (EBSS). In one embodiment, the pouch includes a belt loop 90 for slidably receiving the belt 76, as well as a strap loop 92 for slidably receiving the waist-to-shoulder pad extension strap 64. Attaching the pouch to the belt 76 and waist-to-shoulder pad extension strap 64 in this manner provides a range of articulation that allows the pouch 88 to rotate during activities such as reaching overhead, crawling, bending, twisting and sitting. In addition, this attachment configuration allows the EBSS system to be removed from the pouch 88 and separated from both the waist pad 6 and shoulder harness assembly 8 without disconnecting any pneumatic connections.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

The following exemplary embodiments are provided, the numbering of which is not to be construed as designating levels of importance:

Embodiment 1 provides a self-contained breathing apparatus including a support assembly comprising a back frame configured to be positioned adjacent a user's back when worn by the user; a waist pad removably attached to a lower region of the back frame; and a first elongate securing member arranged to removably secure the back frame to the waist pad; wherein the first elongate securing member is configured to allow the waist pad to move within a predetermined range of motion with respect to the back frame.

Embodiment 2 provides a self-contained breathing apparatus of claim 1, wherein the elongate securing member is configured to allow the waist pad to pivot with respect to the back frame.

Embodiment 3 provides a self-contained breathing apparatus according to any one of Embodiments 1-2, wherein the first elongate securing member comprises a flat strip of material.

Embodiment 4 provides a self-contained breathing apparatus according to any one of Embodiments 1-3, wherein the first elongate securing member comprises a first flexible strap.

Embodiment 5 provides a self-contained breathing apparatus according to Embodiments 4, wherein the first flexible strap comprises woven fabric.

Embodiment 6 provides the self-contained breathing apparatus according to Embodiment 5, wherein the woven fabric comprises webbing formed of synthetic fibers.

Embodiment 7 provides a self-contained breathing apparatus according to any one of Embodiments 4-6, wherein the first flexible strap is configured to slidably engage the lower region of the back frame.

Embodiment 8 provides a self-contained breathing apparatus according to any one of Embodiments 4-7, wherein the first flexible strap slidably engages at least a pair of spaced openings contained in the lower region of the back frame.

Embodiment 9 provides a self-contained breathing apparatus according to any one of Embodiments 4-8, wherein the back frame includes a longitudinal axis, and further wherein the first flexible strap is arranged generally perpendicular to the back frame longitudinal axis.

Embodiment 10 provides a self-contained breathing apparatus according to any one of Embodiments 1-9, wherein the lower region of the frame contains a pair of transversely spaced openings adapted to slidably receive the first flexible strap.

Embodiment 11 provides a self-contained breathing apparatus according to any one of Embodiments 4-10, wherein the back frame includes an upper edge, a lower edge, a pair of side edges, and opposed first and second major surfaces, and further wherein at least one end of the first flexible strap is removably connected with the second major surface of the back frame.

Embodiment 12 provides a self-contained breathing apparatus according to any one of Embodiments 4-11, wherein each end of the first flexible strap is removably connected with the second major surface of the back frame.

Embodiment 13 provides a self-contained breathing apparatus according to any one of Embodiments 1-12, wherein the waist pad comprises a front surface for engaging the lower back region of the user and a back surface opposite the front surface, and further wherein the back surface of the waist pad includes a reinforced region.

Embodiment 14 provides a self-contained breathing apparatus according to Embodiment 13, wherein the reinforced region comprises webbing permanently affixed to the waist pad.

Embodiment 15 provides a self-contained breathing apparatus according to any one of Embodiments 4-14, wherein each end of the first flexible strap includes a pair of snap fasteners for removably attaching the first flexible strap to the reinforced region of the waist pad, thereby allowing the waist pad and back frame to be manually separated without the use of tools.

Embodiment 16 provides a self-contained breathing apparatus according to any one of Embodiments 1-15, further comprising a second elongate securing member configured to removably secure the back frame to the waist pad.

Embodiment 17 provides a self-contained breathing apparatus according to Embodiments 16, wherein the second elongate securing member is arranged generally parallel to the back frame longitudinal axis.

Embodiment 18 provides a self-contained breathing apparatus according to any one of Embodiments 16-17, wherein the second elongate securing member comprises a second flexible strap having a first end permanently affixed to the waist pad in the region intermediate the first flexible strap connection points, and a second end extending outwardly from the waist pad for engagement with the back frame.

Embodiment 19 provides a self-contained breathing apparatus according to any one of Embodiments 16-18, wherein the back frame includes a backrest portion and an angled shelf portion extending outwardly from the lower edge of the backrest portion, whereby the backrest portion and angled shelf portion form a generally L-shaped back frame.

Embodiment 20 provides a self-contained breathing apparatus according to any one of Embodiments 16-19, wherein the second end of the second flexible strap includes a retaining device configured to interlock with a mating slot provided in the shelf portion of the back frame.

Embodiment 21 provides a self-contained breathing apparatus according to any one of Embodiments 1-20, wherein the back frame further comprises a reinforcing member or bar extending from the shelf portion to upper region of the backrest portion.

Embodiment 22 provides a self-contained breathing apparatus according to any one of Embodiments 1-21, further comprising a shoulder harness assembly removably attached to the back frame for removably securing the support assembly around the shoulders of the user.

Embodiment 23 provides a self-contained breathing apparatus according to Embodiment 22, wherein the shoulder harness assembly includes a pair of shoulder pads having an upper end removably connected with the upper region of the back frame and a lower end removably connected with the lower region of the back frame.

Embodiment 24 provides a self-contained breathing apparatus according to any one of Embodiments 22-23, wherein the upper ends of the shoulder pads include a strap having a retaining device, and further wherein the upper region of the back frame contains a slot for matingly receiving the upper shoulder pad retaining element, thereby providing manually releasable engagement between the upper ends of the shoulder pads and the upper region of the back frame.

Embodiment 25 provides a self-contained breathing apparatus according to any one of Embodiments 22-24, wherein the lower ends of the shoulder pads are connected with the lower region of the back frame by adjustable waist-to-shoulder pad extension straps.

Embodiment 26 provides a self-contained breathing apparatus according to any one of Embodiments 22-25, wherein the lower ends of the shoulder pads include buckles for slidably received the waist-to-shoulder pad extension straps.

Embodiment 27 provides a self-contained breathing apparatus according to any one of Embodiments 22-26, wherein the waist-to-shoulder pad extension straps include retaining devices configured to matingly engage slots provided in the lower region of the back frame, thereby providing manually releasable engagement between the waist-to-shoulder pad extension straps and the lower region of the back frame.

Embodiment 28 provides a self-contained breathing apparatus according to any one of Embodiments 22-27, wherein the shoulder harness assembly and back frame are manually separable without the use of tools, and further wherein the shoulder harness assembly can be manually separated from the back frame without breaking any electrical or pneumatic connections.

Embodiment 29 provides a self-contained breathing apparatus according to any one of Embodiments 22-28, wherein each shoulder pad includes a primary portion and a flap portion arranged to form a raceway for receiving at least one wire, cable or tube.

Embodiment 30 provides a self-contained breathing apparatus according to any one of Embodiments 22-29, wherein the flap portion includes an end removably coupled with the primary portion, thereby providing access to the raceway.

Embodiment 31 provides a self-contained breathing apparatus according to any one of Embodiments 1-30, further comprising an adjustable belt for removably securing the support assembly to the waist of the user.

Embodiment 32 provides a self-contained breathing apparatus according to any one of Embodiments 1-31, further comprising an EBSS pouch for stowing an Emergency Breathing Support System removably and pivotably secured to the belt and the waist-to-shoulder pad extension strap.

What is claimed is:

1. A support assembly for a self-contained breathing apparatus, the support assembly comprising:
a. a back frame configured to be positioned adjacent a user's back when worn by the user, the back frame having an upper region and a lower region;
b. a waist pad removably attached to the lower region of the back frame; and
c. a first elongate securing member arranged to removably secure the back frame to the waist pad, wherein the first elongate securing member is configured to allow the waist pad to move within a predetermined range of motion with respect to the back frame.

2. A support assembly as defined in claim 1, wherein the first elongate securing member is a first flexible strap configured to allow the waist pad to pivot with respect to the back frame.

3. A support assembly as defined in claim 1, wherein the first elongate securing member comprises a flat strip of woven fabric material.

4. A support assembly as defined in claim 2, wherein the first flexible strap is configured to slidably engage the lower region of the back frame.

5. A support assembly as defined in claim 4, wherein the back frame includes an upper edge, a lower edge, a pair of side edges, and opposed first and second major surfaces, and further wherein at least one end of the first flexible strap is removably connected with the second major surface of the back frame.

6. A support assembly as defined in claim 5, wherein each end of the first flexible strap is removably connected with the second major surface of the back frame.

7. A support assembly as defined in claim 1, wherein the waist pad comprises a front surface for engaging the lower back region of the user and a back surface opposite the front surface, and further wherein the back surface of the waist pad includes a reinforced region.

8. A support assembly as defined in claim 2, wherein each end of the first flexible strap includes a pair of snap fasteners for removably attaching the first flexible strap to the reinforced region of the waist pad, thereby allowing the waist pad and back frame to be manually separated without the use of tools.

9. A support assembly as defined in claim 1, further comprising a second elongate flexible securing member configured to removably secure the back frame to the waist pad.

10. A support assembly as defined in claim 9, wherein the second elongate flexible securing member is arranged generally parallel to the back frame longitudinal axis.

11. A support assembly as defined in claim 9, wherein the second elongate flexible securing member comprises a second flexible strap having a first end permanently affixed to the waist pad in the region intermediate the first flexible strap connection points, and a second end extending outwardly from the waist pad for engagement with the back frame.

12. A support assembly as defined in claim 11, wherein the back frame includes a backrest portion and an angled shelf portion extending outwardly from the lower edge of the backrest portion, whereby the backrest portion and angled shelf portion form a generally L-shaped back frame.

13. A support assembly as defined in claim 11, wherein the second end of the second flexible strap includes a retaining device configured to interlock with a mating slot provided in the shelf portion of the back frame.

14. A support assembly as defined in claim 1, wherein the back frame further comprises a reinforcing member extending from the shelf portion to the upper region of the backrest portion.

15. A support assembly as defined in claim 1, further comprising a shoulder harness assembly removably attached to the back frame for removably securing the support assembly around the shoulders of the user.

16. A support assembly as defined in claim 15, wherein the shoulder harness assembly includes a pair of shoulder pads having an upper end removably connected with the upper region of the back frame and a lower end removably connected with the lower region of the back frame.

17. A support assembly as defined in claim 16, wherein the upper ends of the shoulder pads include a strap having a retaining device, and further wherein the upper region of the back frame contains a slot for matingly receiving the upper shoulder pad retaining element, thereby providing manually releasable engagement between the upper ends of the shoulder pads and the upper region of the back frame.

18. A support assembly as defined in claim 17, wherein the lower ends of the shoulder pads are connected with the lower region of the back frame by adjustable waist-to-shoulder pad extension straps.

19. A support assembly as defined in claim 18, wherein the lower ends of the shoulder pads include buckles for slidably received the waist-to-shoulder pad extension straps.

20. A support assembly as defined in claim 19, wherein the shoulder harness assembly and back frame are manually separable without the use of tools, and further wherein the shoulder harness assembly can be manually separated from the back frame without breaking any electrical or pneumatic connections.
